(19) United States
(12) Patent Application Publication
(10) Pub. No.: US 2022/0083055 A1
(43) Pub. Date: Mar. 17, 2022

(54) SYSTEM AND METHOD FOR ROBOT INTERACTIONS IN MIXED REALITY APPLICATIONS

(71) Applicants: UNIVERSITE GRENOBLE ALPES, SAINT MARTIN D'HERES (FR); CENTRE NATIONAL DE LA RECHERCHE SCIENTIFIQUE, PARIS CEDEX 16 (FR); INSTITUT POLYTECHNIQUE DE GRENOBLE, GRENOBLE (FR)

(72) Inventors: Vincent RIGAU, GRENOBLE (FR); Etienne HUBERT, GRENOBLE (FR); Nicolas MARCHAND, MONTBONNOT (FR); John-Jairo MARTINEZ-MOLINA, GONCELIN (FR); Kevin SILLAM, VALENCE (FR); Bruno BOISSEAU, LOCMINE (FR); Jonathan DUMON, FROGES (FR)

(21) Appl. No.: 17/425,490

(22) PCT Filed: Jan. 30, 2020
(86) PCT No.: PCT/EP2020/052321

§ 371 Date: Jul. 23, 2021

(30) Foreign Application Priority Data
Jan. 31, 2019 (FR) 1900974

(51) Int. Cl. G05D 1/00; G06T 19/00; G06F 3/01; B64C 39/02

(52) U.S. Cl. CPC G05D 1/0044; G06T 19/006; G06F 3/011; A63F 13/65; G05D 1/0038; B64C 2201/027; B64C 2201/12; B64C 39/024

(57) ABSTRACT

The present disclosure relates to a processing device for implementing a mixed reality system, the processing device comprising: one or more processing cores; and one or more instruction memories storing instructions that, when executed by the one or more processing cores, cause the one or more processing cores to: maintain a virtual world involving at least a first virtual replica corresponding to a first robot in the real world; generate one or more virtual events impacting the first virtual replica in the virtual world; generate a control signal (CTRL) for controlling the first robot in response to the one or more virtual events; and transmit the control signal (CTRL) to the first robot to modify the behavior of the first robot and provide a real world response to the one or more virtual events.

### Cross References to Related Applications

The present patent application claims priority from International Application Number PCT/EP2020/052321 filed on Jan. 30, 2020 which claims benefit of the French patent application filed on Jan. 31, 2019 and assigned application serial number FR19/00974, the contents of which is hereby incorporated by reference.

### TECHNICAL FIELD

The present disclosure relates to the field of control systems for robots and, in particular, to a system permitting augmented and mixed reality applications.

### BACKGROUND ART

It has been proposed to provide systems permitting augmented and mixed reality applications.

“Augmented reality” corresponds to a direct or indirect live view of a physical real world environment whose elements are “augmented” by computer-generated information, such as visual and audio information, that is superposed on the live view.

“Mixed reality”, also known as hybrid reality, is the merging of real and virtual worlds to produce new environments and visualizations where physical and digital objects can coexist and interact in real-time. Mixed reality derives its name from the fact that the world is neither entirely physical nor entirely virtual, but is a mixture of both worlds.

There is however a technical difficulty in providing mixed reality environments in which events involving virtual elements in a virtual world can be synchronized with the dynamic behavior of real objects in the physical world.

### SUMMARY OF INVENTION

It is an aim of embodiments of the present description to at least partially address one or more difficulties in the prior art.

According to one aspect, there is provided a processing device for implementing a mixed reality system, the processing device comprising: one or more processing cores; and one or more instruction memories storing instructions that, when executed by the one or more processing cores, cause the one or more processing cores to: maintain a virtual world involving at least a first virtual replica corresponding to a first robot in the real world; generate one or more virtual events impacting the first virtual replica in the virtual world; generate a control signal for controlling the first robot in response to the one or more virtual events; and transmit the control signal to the first robot to modify the behavior of the first robot and provide a real world response to the one or more virtual events.

According one embodiment, the instructions further cause the one or more processing cores to receive, prior to generating the control signal, a user or computer-generated command intended to control the first robot, wherein generating the control signal comprises modifying the user or computer-generated command based on the one or more virtual events.

According one embodiment, the instructions further cause the one or more processing cores to limit the control signal resulting from a user or computer-generated command in the absence of a virtual event to a first range, wherein the control signal providing a real world response to the one or more virtual events exceeds the first range.

According one embodiment, the instructions further cause the one or more processing cores to generate a mixed reality video stream to be relayed to a display interface, the mixed reality video stream including one or more virtual features from the virtual world synchronized in time and space and merged with a raw video stream captured by a camera.

According one embodiment, the instructions cause the one or more processing cores to generate virtual features in the mixed reality video stream representing virtual events triggered by the behavior of the first robot in the real world.

According one embodiment, the instructions further cause the one or more processing cores to continuously track the 6 Degrees of Freedom coordinates of the first robot corresponding to its position and orientation based on tracking data provided by a tracking system.

According one embodiment, the instructions further cause the one or more processing cores to generate the control signal to ensure contactless interactions of the first robot with one or more real static or mobile objects or further robots, based at least on the tracking data of the first robot and the 6 Degrees of Freedom coordinates of the one or more real static or mobile objects or further robots.

A mixed reality system comprising: the above processing device; an activity zone comprising the first robot and one or more further robots under control of the processing device; and a tracking system configured to track relative positions and orientations of the first robot and the one or more further robots.

According one embodiment, the first robot is a drone or land-based robot.

According one embodiment, the mixed reality system further comprises one or more user control interfaces for generating user commands.

According to a further aspect, there is provided a method of controlling one or more robots in a mixed reality system, the method comprising: maintaining, by one or more processing cores under control of instructions stored by one or more instruction memories, a virtual world involving at least a first virtual replica corresponding to a first robot in the real world; generating one or more virtual events impacting the first virtual replica in the virtual world; generating a control signal for controlling the first robot in response to the one or more virtual events; and transmitting the control signal to the first robot to modify the behavior of the first robot and provide a real world response to the one or more virtual events.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 is a perspective view of a mixed reality system according to an example embodiment of the present disclosure;

FIG. 2 schematically illustrates a computing system of the mixed reality system of

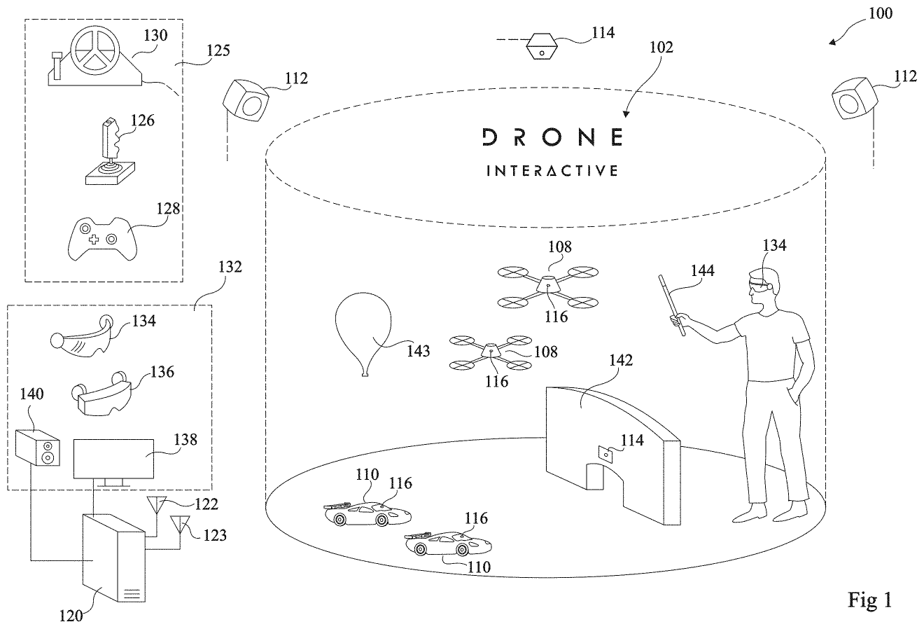

FIG. 1 in more detail according to an example embodiment;

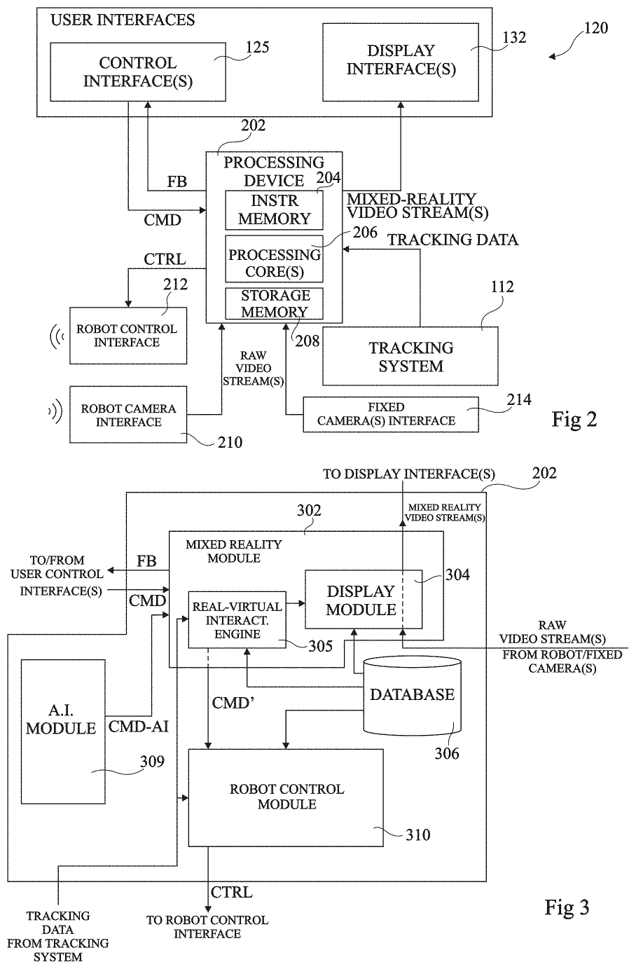

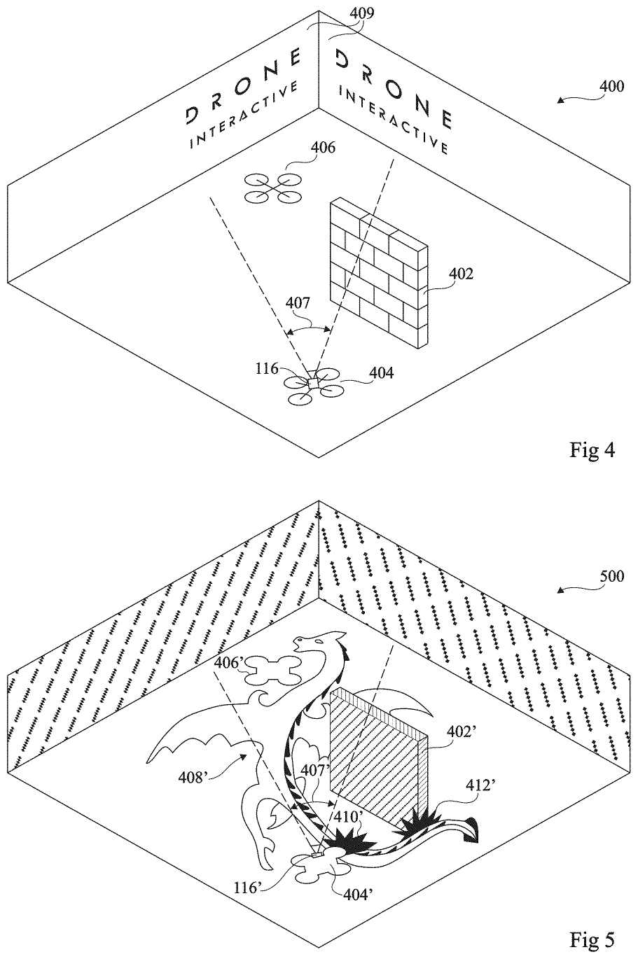

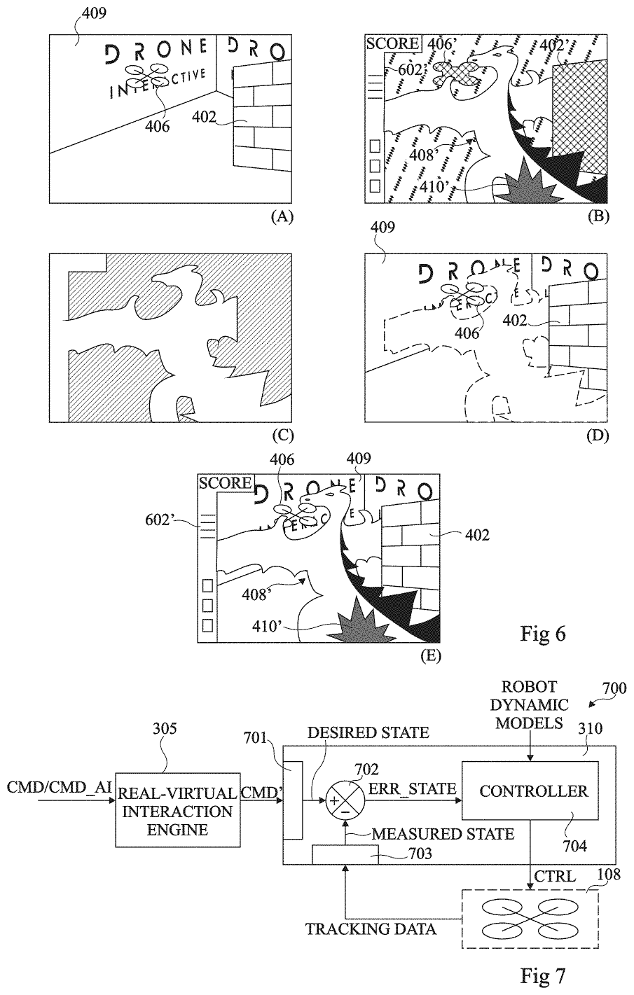

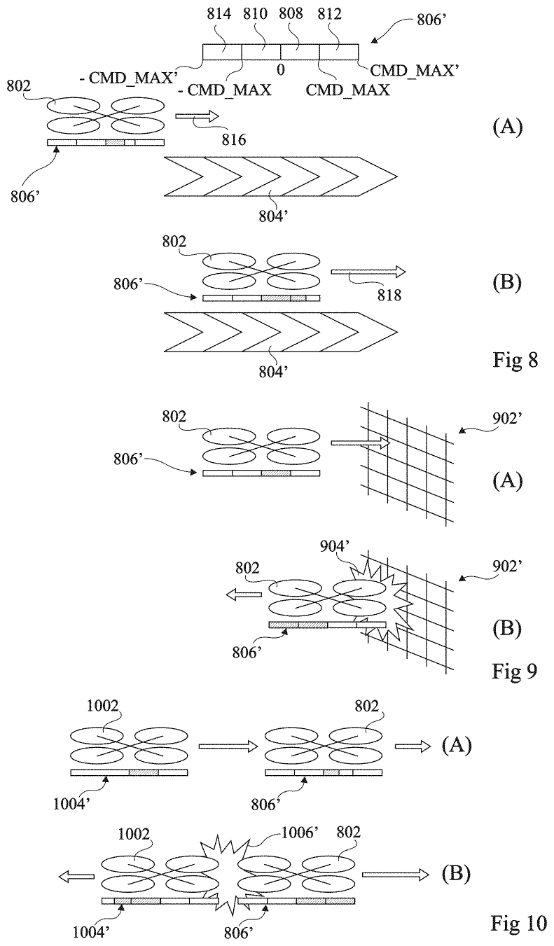

FIG. 3 schematically illustrates a processing device of FIG. 2 in more detail according to an example embodiment;

FIG. 4 represents the real world according to an example embodiment of the present disclosure;

FIG. 5 represents a virtual world corresponding to the real world of FIG. 4;

FIG. 6 illustrates video images during generation of a mixed reality video image;

FIG. 7 schematically illustrates a control loop for controlling a robot based on a command according to an example embodiment;

FIG. 8 illustrates an example of a virtual world feature having a real world effect according to an example embodiment of the present disclosure;

FIG. 9 illustrates a virtual fencing feature according to an example embodiment of the present disclosure; and

FIG. 10 illustrates a simulated contactless collision feature between robots according to an example embodiment of the present disclosure.

### DESCRIPTION OF EMBODIMENTS

Throughout the present disclosure, the term “coupled” is used to designate a connection between system elements that may be direct, or may be via one or more intermediate elements such as buffers, communication interfaces, intermediate networks, etc.

Furthermore, throughout the present description, the following terms will be considered to have the following definitions:

“Robot”—any machine or mechanical device that operates to some extent automatically and to some extent under control of a user. For example, as will be described in more detail hereafter, a robot is for example to some extent remotely controlled via a wireless control interface based on user commands.

“Mixed-reality application”—an application in which there are interactions between the real world and a virtual world. For example, events occurring in the real world are tracked and applied to the virtual world, and events occurring in the virtual world result in real world effects. Some examples of mixed-reality interactive video games are provided at the internet site www.drone-interactive.com. The name “Drone Interactive” may correspond to one or more registered trademarks. While in the following description embodiments of a mixed reality system are described based on an example application of an interactive game, it will be apparent to those skilled in the art that the system described herein could have other applications, such as for maintenance of machines or buildings, for exploration, including space exploration, for the manufacturing industry, such as in a manufacturing chain, for search and rescue, or for training, including pilot or driver training in the context of any of the above applications.

“Virtual replica”—a virtual element in the virtual world that corresponds to a real element in the real world. For example, a wall, mountain, tree or other type of element may be present in the real world, and is also defined in the virtual world based on at least some of its real world properties, and in particular its 6 Degrees of Freedom (DoF) coordinates corresponding to its relative position and orientation, its 3D model or its dynamic behavior in the case of mobile elements. Some virtual replicas may correspond to mobile elements, such as robots, or even to a user in certain specific cases described in more detail below. While the 6 DoF coordinates of static elements are for example stored once for a given application, the 6 DoF coordinates of mobile elements, such as robots, are tracked and applied to their virtual replica in the virtual world, as will be described in more detail below. Finally, the behavior of each virtual replica mimics that of the corresponding mobile elements in the real world.

FIG. 1 is a perspective view of a mixed reality system 100 according to an example embodiment of the present disclosure. FIG. 1 only illustrates the real world elements of the system, the virtual world being maintained by a computing system 120 described in more detail below.

The system 100 for example comprises an activity zone 102 of any shape and dimensions. The activity zone 102 for example defines a volume in which the mixed reality system can operate, and in particular in which a number of robots may operate and in which the 6 DoF coordinates (position and orientation) of the robots can be tracked. While in the example of FIG. 1 the activity zone 102 defines a substantially cylindrical volume, in alternative embodiments other shapes would be possible. The size and shape of the activity zone 102 will depend on factors such as the number and size of the robots, the types of activities performed by the robots and any constraints from the real world.

One or more robots are for example present within the activity zone 102 and may interact with each other, with other mobile or static real objects in the activity zone and with virtual elements in the virtual world. For example, the activity zone 102 defines a gaming zone in which robots forming part of a mixed reality game are used. In the example of FIG. 1, the robots include drones 108 and land-based robots in the form of model vehicles 110, although the particular type or types of robots will depend on the game or application. Indeed, the robots could be of any type capable of remote control. The number of robots could be anything from one to tens of robots.

Each of the robots within the activity zone 102 is for example a remotely controlled robot that is at least partially controllable over a wireless interface. It would however also be possible for one or more robots to include wired control lines.

It is assumed herein that each of the robots within the activity zone 102 comprises a source of power, such as a battery, and one or more actuators, motors, etc. for causing parts of each robot to move based on user commands and/or under control of one or more automatic control loops. For example: the drones include one or more propellers creating forward, backward, lateral and/or vertical translations; and the land-based robots in the form of model vehicles include a motor for driving one or more wheels of the vehicle and one or more actuators for steering certain wheels of the vehicle. Of course, the particular types of motors or actuators used for moving the robots will depend on the type of robot and the types of operations it is designed to perform.

The computing system 120 is for example configured to track activity in the real world (within the activity zone 102) and also to maintain a virtual world, and merge the real and virtual worlds in order to provide one or more users and/or spectators with a mixed reality experience, as will now be described in more detail.

The mixed reality system 100 for example comprises a tracking system 112 capable of tracking the relative positions and orientations (6 DoF coordinates) of the robots, and in some cases of other mobile or static objects, within the activity zone 102. The position information is for example tracked with relatively high accuracy, for example with a precision of 1 cm or less, and the orientation is for example measured with a precision of 1 degree or less. Indeed, the overall performance of the system for accurately synchronizing the real and virtual worlds and creating interactions between them will depend to some extent on the accuracy of the tracking data. In some embodiments, the robots have six degrees of freedom, three being translation components and three being rotation components, and the tracking system 112 is capable of tracking the position and orientation of each of them with respect to these six degrees of freedom.

In some embodiments, the robots may each comprise a plurality of active or passive markers (not illustrated) that can be detected by the tracking system 112. The emitters of the tracking system 112 for example emit infrared light, and cameras, which may be integrated in the light emitters, for example detect the 6 DoF coordinates of the robots based on the light reflected by these markers. For example, each tracked object (including robots) has a unique pattern of markers that permit it to be identified among the other tracked objects and for its orientation to be determined. In addition, the tracking system 112 may comprise one or more emitters that emit light at non-visible wavelengths into the activity zone 102. There are many different tracking systems that are available based on this type of tracking technology, an example being the one marketed under the name “Optitrack” (the name “Optitrack” may correspond to a registered trademark).

In further embodiments, the light is in the form of light beams, and the robots comprise light capture elements (not illustrated) that detect when the robot traverses a light beam, and by identifying the light beam, the 6 DoF coordinates of the robot can be estimated. Such a system is for example marketed by the company HTC under the name “Lighthouse” (the names “HTC” and “Lighthouse” may correspond to registered trademarks).

It would also be possible for the robots to include on-board tracking systems, for example based on inertial measurement units or any other positioning devices, permitting the robots to detect their 6 DoF coordinates (position and orientation), and relay this information to the computing system 120.

In yet further embodiments, different types of tracking systems could be used, such as systems based on UWB (ultra-wide band) modules, or systems based on visible cameras in which image processing is used to perform object recognition and to detect the 6 DoF coordinates (position and orientation) of the robots.

The computing system 120 for example receives information from the tracking system 112 indicating, in real time, the 6 DoF coordinates (position and orientation) of each of the tracked objects (including robots) in the activity zone 102. Depending on the type of tracking system, this information may be received via a wired connection and/or via a wireless interface.

The mixed reality system 100 comprises cameras for capturing real time (streaming) video images of the activity zone that are processed to create mixed reality video streams for display to users and/or spectators. For example, the mixed reality system 100 comprises one or more fixed cameras 114 positioned inside or outside the activity zone 102 and/or one or more cameras 116 mounted on some or all of the robots. One or more of the fixed cameras 114 or of the robot cameras 116 is for example a pan and tilt camera, or a pan-tilt-zoom (PTZ) camera. In the case of a camera 114 external to the activity zone 102, it may be arranged to capture the entire zone 102, providing a global view of the mixed reality scene.

The video streams captured by the cameras 114 and/or 116 are for example relayed wirelessly to the computing system 120, although for certain cameras, such as the fixed cameras 114, wired connections could be used.

The computing system 120 is for example capable of wireless communications with the robots within the activity zone 102. For example, the computing system 120 includes, for each robot, a robot control interface with one or several antennas 122 permitting wireless transmission of the control signals to the robots and a robot video interface with one or several antennas 123 permitting the wireless reception of the video streams from the robot cameras 116. While a single antenna 122 and a single antenna 123 are illustrated in FIG. 1, the number of each antenna is for example equal to the number of robots.

The computing system 120 is for example a central system via which all of the robots in the activity zone 102 can be controlled, all interactions between the real and virtual worlds are managed, and all video processing is performed to create mixed reality video streams. Alternatively, the computing system 120 may be formed of several units distributed at different locations.

User interfaces for example permit users to control one or more of the robots and/or permit users or spectators to be immersed in the mixed reality game or application by seeing mixed reality images of the activity zone 102. For example, one or more control interfaces 125 are provided, including for example a joystick 126, a hand-held game controller 128, and/or a steering wheel 130, although any type of control interface could be used. The control interfaces 125 are for example connected by wired connections to the computer system 120, although in alternative embodiments wireless connections could be used. Furthermore, to permit users and/or spectators to be immersed in the mixed reality game or application by seeing mixed reality images of the activity zone 102, one or more display interfaces 132 are provided, such as a virtual reality (VR) headset or video glasses 136, and/or a display screen 138, and/or a see-through augmented reality (AR) headset 134, although any type of display could be used. In some embodiments, audio streams are provided to each user. For example, the headsets 134 and 136 are equipped with headphones. Additionally or alternatively, a speaker 140 may provide audio to users and/or to spectators. The display interfaces 132 are for example connected by wired connections to the computer system 120, although in alternative embodiments wireless connections could be used.

The activity zone 102 for example comprises, in addition to the robots, one or more further static or mobile objects having virtual replicas in the virtual world. For example, in FIG. 1, a wall 142 and a balloon 143 are respectively static and mobile objects that are replicated in the virtual world. There could also be any other objects, such as static or mobile scene features, decorations, balls, pendulums, gates, swinging doors/windows, etc. The 6 DoF coordinates (position and orientation) of these objects can be tracked by the tracking system 112. As will be described below, there may be interactions between the robots and the wall 142, and/or the balloon 143 and/or any other objects that can result in the computing system 120 generating virtual events in the virtual world, and also physical responses in the real world. Of course, any type of fixed or mobile object could be present in the activity zone 102 and replicated in the virtual world. In some embodiments, all real elements, mobile or fixed, within the activity zone 102 have a virtual replica. This permits the 6 DoF coordinates (position and orientation) of these real elements to be stored or tracked by the computing system 120, and thus permits, for example, collisions of robots with these objects to be avoided.

In some embodiments, users may have direct interaction with robots in the activity zone 102. For example, FIG. 1 illustrates a user in the activity zone 102 wearing a see-through augmented reality (AR) headset 134 that permits a direct view of the mixed reality images of the activity zone 102. The tracking system 112 is for example capable of tracking the 6 DoF coordinates (position and orientation) of the AR headset 134, for example based on markers fixed to the AR headset 134, such that the appropriate mixed reality images can be generated and supplied to the display of the AR headset 134.

In some cases, one or more users may interact with one or more robots in a different manner than by using one of the control interfaces 125 described above (a game controller, joystick or the like). For example, the user in the activity zone 102 may use a wand 144 or any other physical object to interact directly with the robots. The tracking system 112 for example tracks movements of the wand 144, and the computing system 120 for example controls the robots as a function of these movements. For example, one or more drones may be repulsed by the wand 144, or directed to areas indicated by the wand 144, although any type of interaction could be envisaged.

FIG. 2 schematically illustrates an example of architecture of the computing system 120 of the mixed reality system of FIG. 1 in more detail.

The system 120 for example comprises a processing device (PROCESSING DEVICE) 202 implemented by one or more networked computers. The processing device 202 for example comprises an instruction memory (INSTR MEMORY) 204 and one or more processing cores (PROCESSING CORE(S)) 206. The processing device 202 also for example comprises a storage memory (STORAGE MEMORY) 208, storing the data processed by the processing cores 206, as will be described in more detail below.

The processing device 202 for example receives user commands (CMD) from the one or more control interfaces (CONTROL INTERFACE(S)) 125. A user command corresponds to the user's desired control of the robot, indicating for example a desired displacement and/or other desired behavior of the robot. In addition, user commands may also correspond to any user's desired triggering action in the mixed reality game or application. In some embodiments, the processing device 202 generates feedback signals FB that are sent back to the control interface(s) 125. These feedback signals for example cause the user interface(s) 125 to vibrate in response to events in the mixed reality game or application, or provide other forms of feedback response (haptic feedback or other).

The computing system 120 for example comprises a robot camera(s) interface (ROBOT CAMERA(S) INTERFACE) 210 that wirelessly receives raw video stream(s) (RAW VIDEO STREAM(S)) from the robot cameras 116 of one or more robots and transmits these raw video stream(s) to the processing device 202. In addition, the computing system 120 for example comprises a robot control interface (ROBOT CONTROL INTERFACE) 212 that receives robot control signals (CTRL) from the processing device 202 and wirelessly transmits these control signals to one or more robots. The computing system 120 for example comprises a fixed camera(s) interface (FIXED CAMERA(S) INTERFACE) 214 that receives raw video streams from the fixed cameras 114 via a wireless or wired interface and transmits these raw video streams to the processing device 202. While not illustrated in FIG. 2, the processing device 202 may also generate control signals for controlling the pan, tilt and/or zoom of the fixed camera(s) 114 and/or the robot camera(s) 116.

The processing device 202 for example modifies the raw video streams received from the fixed camera(s) 114 and/or the robot camera(s) 116 to generate mixed reality video streams (MIXED REALITY VIDEO STREAM(S)), and in some cases (not illustrated) audio streams, which are transmitted to the display interfaces (DISPLAY INTERFACE(S)) 132.

The processing device 202 also for example receives tracking data (TRACKING DATA) corresponding to the 6 DoF coordinates (position and orientation) of all tracked objects (robots and static/mobile objects) from the tracking system (TRACKING SYSTEM) 112.

FIG. 3 schematically illustrates the functionalities of the processing device 202 of FIG. 2 in more detail, and in particular represents an example of software modules implemented in the processing device 202 by software loaded to the instruction memory 204 and executed by the processing cores 206. Of course, the processing device 202 may have various implementations, and some functionalities could be implemented by hardware or by a mixture of hardware and software.

The processing device 202 for example implements a mixed reality module (MIXED REALITY MODULE) 302, comprising a display module (DISPLAY MODULE) 304 and a real-virtual interaction engine (REAL-VIRTUAL INTERACT. ENGINE) 305. The processing device 202 also for example comprises a database (DATABASE) 306 stored in the storage memory 208, a robot control module (ROBOT CONTROL MODULE) 310 and in some cases an artificial intelligence module (A.I. MODULE) 309.

The mixed-reality module 302 receives user commands (CMD) for controlling corresponding robots from the control interface(s) (CONTROL INTERFACE(S)) 125 of the user interfaces (USER INTERFACES), and in some embodiments generates the feedback signal(s) FB sent back to these control interfaces 125. Additionally or alternatively, one or more robots may be controlled by commands (CMD AI) generated by the artificial intelligence module 309 and received by the mixed-reality module 302.

The database 306 for example stores one or more of the following:
robot data, including at least for each robot, a 3D model and a dynamic model respectively indicating the 3D shape and the dynamic behavior of the robot;
real object data, including at least for each static/mobile real object in the activity zone 102 a 3D model, and for the static ones, their permanent 6 DoF coordinates (position and orientation);
mixed reality application data, including for example 3D models of each virtual element contained in the virtual world, head-up display (HUD) data, special effects (FX) data, some specific rules depending on the application, and in the case of a video game, gameplay data;
camera data, including at least for each camera (the fixed camera(s) 114 and the robot camera(s) 116) their intrinsic and extrinsic parameters, and for the fixed ones, their permanent 6 DoF coordinates (position and orientation).

The mixed reality module 302 constructs and maintains the virtual world, which is composed of all the virtual elements including the virtual replicas of the robots and the static/mobile real objects in the activity zone 102. In particular, the real-virtual interaction engine 305 receives the tracking data (TRACKING DATA) from the tracking system 112 and uses the data stored in the database 306 to ensure synchronization of the 6 DoF coordinates (position and orientation) between the real elements (the robots and the static/mobile real objects in the activity zone 102) and their corresponding virtual replicas in the virtual world.

The engine 305 also for example generates modified command signals CMD′ for controlling one or more robots based on initial user command (CMD) or AI generated command (CMD_AI) and the real-virtual interactions relating to the one or more robots. For example, these real-virtual interactions are generated as a function of the tracked 6 DoF coordinates (position and orientation) of the robots, the robot data (including the robot dynamic models) from the database 306, and on events occurring in the mixed reality application and/or, depending on the application, on other specific rules from the database 306. In the case of a video game, these rules may be defined in the gameplay data. The engine 305 also for example implements anti-collision routines in order to prevent collisions between robots themselves and/or between any robot and another real object in the activity zone 102, and in some cases between any robot and a virtual element in the virtual world. Some examples of real-virtual interactions will be described below with reference to FIGS. 8, 9 and 10.

The display module 304 for example generates mixed reality video stream(s) based on the raw video stream(s) from the fixed camera(s) 114 and/or the robot camera(s) 116 and relays it to corresponding display interfaces 132 after incorporating virtual features (such as the view of one or more virtual elements, head-up display data, visual special effects, etc.) generated by the real-virtual interaction engine 305. For example, virtual features generated by the real-virtual interaction engine 305 are synchronized in time and space and merged with the raw video stream(s). For example, the view of one or more virtual elements in the mixed reality application is presented to a display interface in a position and orientation that depends of the field of view and the 6 DoF coordinates (position and orientation) of the corresponding fixed or robot camera 114/116.

The robot control module 310 for example receives the modified command signals CMD′ generated by the real-virtual interaction engine 305 and generates one or more control signals CTRL based on these command signals for controlling one of more of the robots (TO ROBOT CONTROL INTERFACE), as will be described in more detail below in relation with FIG. 7.

Operation of the mixed reality module 302 will now be described in more detail with reference to FIGS. 4, 5 and 6(A) to 6(E).

FIG. 4 is a perspective real world view of an activity zone 400. In the example of

FIG. 4, the activity zone 400 includes a static wall 402, and two robots that are two drones 404 and 406. Furthermore, the background of the activity zone 400 includes a backdrop 409 with printed graphics. The drone 404 has for example a camera 116 having a field of view 407. In this example, the camera 116 is rigidly attached to the drone, but in alternative embodiments the camera 116 could be a pan and tilt camera, or a PTZ camera.

FIG. 5 is a perspective view of the virtual world 500 corresponding to the activity zone 400 of FIG. 4, and at the same time instance as that of FIG. 4. The virtual world includes the virtual replicas 402′, 404′ and 406′ corresponding respectively to the real wall 402 and the real drones 404 and 406. The positions and orientations of the virtual replicas 402′, 404′ and 406′ in the virtual world are the same as those of the real wall 402 and the real drones 404 and 406 in the real world, and can for example be determined by the mixed reality module 302 based on the 6 DoF coordinates of the drones 404 and 406 provided by the tracking system 112 and on the 6 DoF coordinates of the real wall 402 stored in the database 306. In the same way, the virtual replica 404′ of the drone 404 has a virtual camera 116′ having a virtual field of view 407′ corresponding to the field of view 407 of the real drone 404. In the example of FIG. 5, there is no background in the virtual world. The virtual world 500 also includes some purely virtual elements, in particular a flying dragon 408′, a virtual explosion 410′ between the virtual replica 404′ of the drone 404 and the dragon's tail, and a virtual explosion 412′ between the dragon's tail and an edge of the virtual replica 402′ of the wall 402.

The display module 304 generates a mixed reality video stream by merging the raw video stream of the real world captured by the camera 116 of the real drone 404 with virtual images of the virtual world corresponding to the view point of the virtual camera 116′ of the virtual replica 404′ of the drone 404, as will now be described in more detail with reference to FIGS. 6(A) to 6(E).

FIG. 6(A) is a real image extracted from the raw video stream captured by the camera 116 of the drone 404 at the same time instance as that of FIGS. 4 and 5. By corresponding to the field of view 407, this image includes the drone 406, part of the wall 402, and part of the backdrop 409 of the activity zone. This image is for example received by the display module 304 of the mixed reality module 302 from the camera 116 of the drone 404 via the robot camera interface 210 of FIG. 2.

FIG. 6(B) illustrates a computer-generated image corresponding to the view point of the virtual camera 116′ of the virtual replica 404′ of the drone 404 at the same time instance as that of FIGS. 4 and 5. This image includes part of the dragon 408′, part of the explosion 410′ and parts of the virtual replicas 402′ and 406′ of the wall 402 and the drone 406. The image also for example includes, in the foreground, a head-up display (HUD) 602′ indicating for example a player score and/or other information according to the mixed-reality application. In the present embodiment, the image is constructed from the following planes:
1st plane: the HUD 602′;
2nd plane: the explosion 410′;
3rd plane: the tail portion of the dragon 408′;
4th plane: the virtual replica 402′ of the wall;
5th plane: the wings of the dragon 408′;
6th plane: the virtual replica 406′ of the drone;
7th plane: the head of the dragon 408′;
Background plane: empty, as represented by dashed-dotted stripes in FIG. 6B.

FIG. 6(C) illustrates an example of an image mask generated from the image of FIG. 6(B) by the display module 304 in which zones of the real image of FIG. 6(A) that are to be maintained in the final image (the background and visible parts of the virtual replicas) are shown with diagonal stripes, and zones to be replaced by visible parts of the purely virtual elements of FIG. 6(B) are shown in white.

FIG. 6(D) shows the image of FIG. 6(A) after application of the image mask of FIG. 6(C). The contours of the zones in which the virtual elements will be added are shown by dashed lines.

FIG. 6(E) represents the final image forming part of the mixed reality video stream, and corresponding to the image of FIG. 6(D), on which the virtual elements of FIG. 6(B) have been merged. In this example, the final image includes the merging of the original video images of the drone 406, of the wall 402, and of the backdrop 409, with the purely virtual elements 408′, 410′ and 602′. This merging is performed while taking into account the possible occultations between the various planes of the image.

In some embodiments, the display module 304 generates, for each image of the raw video stream being processed, an image mask similar to that of FIG. 6(C), which is applied to the corresponding image of the raw video stream. The real-virtual interaction engine 305 also for example supplies to the display module 304 an image comprising the virtual elements to be merged with the real image, similar to the example of FIG. 6(B), and the display module 304 for example merges the images to generate the final image similar to that of FIG. 6(E).

The display module 304 for example processes each raw video stream received from a robot/fixed camera 116/114 in a similar manner to the example of FIGS. 6(A) to 6(E) in order to generate corresponding mixed reality video streams to each display interface.

FIG. 6 is used to illustrate the principles that can be used to generate the mixed reality images, and it will be apparent to those skilled in the art that the implementation of these principles could take various forms.

FIG. 7 schematically illustrates a control loop 700 for controlling a robot, such as a drone 108 of FIG. 1, according to an example embodiment, using the real-virtual interaction engine (REAL-VIRTUAL INTERACTION ENGINE) 305 and the robot control module 310 of FIG. 3.

As represented in FIG. 7, user commands (CMD) or AI generated commands (CMD_AI) are received by the real-virtual interaction engine 305, and processed by taking into account the events occurring in the mixed reality application and/or other specific rules such as anti-collision routines, in order to generate modified commands CMD′, which are supplied to the robot control module 310.

The robot control module 310 for example comprises a transfer function module 701 that transforms each modified command CMD′ into a desired robot state (DESIRED STATE), including the desired 6 DoF coordinates (position and orientation) of the robot. The module 310 also comprises a subtraction module 702 that continuously calculates an error state value (ERR_STATE) as the difference between the desired robot state and the measured robot state (MEASURED STATE) generated by a further transfer function module 703 based on the tracking data (TRACKING DATA) provided by the tracking system 112. The error state value is provided to a controller (CONTROLLER) 704, which for example uses the robot dynamic model (ROBOT DYNAMIC MODELS) from the database 306, and aims to generate control signals CTRL that minimize this error state value. The generated control signals CTRL are for example wirelessly transmitted to the robots 108 via the robot control interface.

The modification of the command signals CMD by the real-virtual interaction engine 305 will now be described in more detail through a few examples with reference to FIGS. 8 to 10. These figures illustrate an example of the control of a drone 802. However, it will be apparent to those skilled in the art that the principles could be applied to other types of robot.

FIG. 8(A) illustrates a first example in which the drone 802 flies towards a virtual boost zone 804′, which for example exists only as a virtual element in the virtual world. A thrust gage 806′ is illustrated in association with the drone 802, and indicates, with a shaded bar, the level of thrust applied to the drone at a given time instance. This thrust gage 806′ is presented in order to assist in the understanding of the operation of the real-virtual interaction engine 305, and such a virtual gage may or may not be displayed to a user, for example as part of the HUD, depending on the mixed reality application.

An enlarged version of the thrust gage 806′ is shown at the top of FIG. 8(A). It can be seen that this gage is divided into four portions. A central point corresponds to zero thrust (0), and the zones to the left of this correspond to reverse thrust applied to the drone 802, whereas the zones to the right of this correspond to forward thrust applied to the drone 802. A portion 808 covers a range of forward thrust from zero to a limit CMD_MAX of the user command, and a portion 810 covers a range of reverse thrust from zero to a limit −CMD_MAX of the user command. A portion 812 covers a range of forward thrust from CMD_MAX to a higher level CMD_MAX′, and a portion 814 covers a range of reverse thrust from −CMD_MAX to a level −CMD_MAX′. The levels CMD_MAX′ and −CMD_MAX′ for example correspond to the actual limits of the drone in terms of thrust. Thus, the portions 812 and 814 add a flexibility to the real-virtual interaction engine 305 enabling it to exceed the normal user command limits to add real world effects in response to virtual events, as will be described in more detail below. In some embodiments, the power applied within the robot to generate the thrust resulting from the command CMD_MAX′ is at least 50% greater than the power applied within the robot to generate the thrust resulting from the command CMD_MAX.

In the example of FIG. 8(A), the thrust gage 806′ indicates a forward thrust below the level CMD MAX, this thrust for example resulting only from the user command CMD for the drone 802. Thus, the drone moves at moderate speed towards the zone 804′, as represented by an arrow 816.

FIG. 8(B) illustrates the drone 802 a bit later as it reaches the virtual boost zone 804′.

The real-virtual interaction engine 305 detects the presence of the drone 802 in this zone 804′, and thus increases the thrust to a boosted level between CMD_MAX and CMD_MAX′ as indicated by the thrust gage 806′. As represented by an arrow 818, the speed of the drone 802 for example increases as a result to a high level. For example, the real-virtual interaction engine 305 determines the new thrust based on the user command CMD, increased by a certain percentage, such as 100%.

FIG. 9 illustrates an example of virtual fencing feature, based on a virtual wall 902′.

FIG. 9(A) corresponds to a first time instance in which the drone 802 is moving towards the virtual wall 902′, for example at the maximum thrust CMD MAX of the user command, resulting in relatively high speed.

FIG. 9(B) illustrates the situation just following the collision. When the drone 802 reaches a point at a given distance from the wall 902′, the real-virtual interaction engine 305 for example simulates a collision by applying maximum reverse thrust −CMD_MAX′ to the drone 802 to simulate a rebound from the wall 902′. In response, the drone 802 for example slows rapidly to a halt, and then starts reversing, for example without ever passing the virtual wall 902′. Simultaneously, a virtual explosion 904′ may be generated in the virtual world in order to give some visual feedback of the virtual collision to the users/spectators.

While in the example of FIG. 9 the wall 902′ is purely virtual, the same approach could be used to avoid collisions with real objects in the activity zone 102.

FIG. 10 illustrates an example of a simulated contactless collision between two drones.

FIG. 10(A) corresponds to a first time instance in which the drone 802 is moving at relatively low speed in a forward direction, and a further drone 1002 is moving in the same direction towards the drone 802 at maximum thrust CMD_MAX and thus at relatively high speed.

FIG. 10(B) illustrates the situation after a simulated contactless collision between the drones 802 and 1002. For example, when the drone 1002 reaches a certain distance from the drone 802, the real-virtual interaction engine 305 simulates a collision by applying high reverse thrust to the drone 1002, as represented by the thrust gauge 1004′, for example between the limits −CMD MAX and −CMD-MAX′, to simulate a rebound from the collision. The real-virtual interaction engine 305 also for example increases the thrust of the drone 802, for example to the maximum forward thrust CMD_MAX′, in order to simulate the drone 802 being strongly pushed from behind. Simultaneously, a virtual explosion 1006′ may be generated in the virtual world in order to give some visual feedback of the contactless collision to the users/spectators.

In some cases, the real-virtual interaction engine 305 may also simulates damage to a robot following a collision, for example by reducing any user command CMD by a certain percentage to simulate a loss of thrust.

An advantage of the embodiments described herein is that they permit a mixed reality system to be implemented in which events in a virtual world can be used to generate responses in the real world. This is achieved by generating, by the real-virtual interaction engine 305, modified robot commands to create specific robot behaviors in the real world. This for example permits relatively close simulation of virtual events in the real world, leading to a particularly realistic user experience.

Having thus described at least one illustrative embodiment, various alterations, modifications and improvements will readily occur to those skilled in the art. For example, it will be apparent to those skilled in the art that the various functions of the computing system described herein could be implemented entirely in software or at least partially in hardware.

Furthermore, it will be apparent to those skilled in the art that the various features described in relation with the various embodiments could be combined, in alternative embodiments, in any combination.

1. A processing device for implementing a mixed reality system, the processing device comprising:
one or more processing cores; and
one or more instruction memories storing instructions that, when executed by the one or more processing cores, cause the one or more processing cores to:
maintain a virtual world involving at least a first virtual replica corresponding to a first robot in the real world;
generate one or more virtual events impacting the first virtual replica in the virtual world;
generate a control signal (CTRL) for controlling the first robot in response to the one or more virtual events; and
transmit the control signal (CTRL) to the first robot to modify the behaviour of the first robot and provide a real world response to the one or more virtual events.

2. The processing device of claim 1, wherein the instructions further cause the one or more processing cores to receive, prior to generating the control signal (CTRL), a user command intended to control the first robot, wherein generating the control signal (CTRL) comprises modifying the user command based on the one or more virtual events.

3. The processing device of claim 2, wherein the virtual world further involves a second virtual replica corresponding to a second robot in the real world, and wherein the instructions further cause the one or more processing cores to:
generate one or more further virtual events impacting the second virtual replica in the virtual world;
receive a computer-generated command intended to control the second robot;
generate a further control signal (CTRL) by modifying the computer-generated command based on the one or more further virtual events; and
transmit the further control signal (CTRL) to the second robot to modify the behaviour of the second robot and provide a real world response to the one or more further virtual events.

4. The processing device of claim 2, wherein the instructions further cause the one or more processing cores to limit the control signal resulting from a user or computer-generated command in the absence of a virtual event to a first range (−CMD_MAX, CMD_MAX), wherein the control signal providing a real world response to the one or more virtual events exceeds the first range.

5. The processing device of claim 1, wherein the instructions further cause the one or more processing cores to generate a mixed reality video stream to be relayed to a display interface, the mixed reality video stream including one or more virtual features from the virtual world synchronized in time and space and merged with a raw video stream captured by a camera.

6. The processing device of claim 4, wherein the instructions cause the one or more processing cores to generate virtual features in the mixed reality video stream representing virtual events triggered by the behaviour of the first robot in the real world.

7. The processing device of claim 1, wherein the instructions further cause the one or more processing cores to continuously track the 6 Degrees of Freedom coordinates of the first robot corresponding to its position and orientation based on tracking data provided by a tracking system.

8. The processing device of claim 6, wherein the instructions further cause the one or more processing cores to generate the control signal (CTRL) to ensure contactless interactions of the first robot with one or more real static or mobile objects or further robots, based at least on the tracking data of the first robot and the 6 Degrees of Freedom coordinates of the one or more real static or mobile objects or further robots.

9. A mixed reality system comprising:
a processing device, comprising:
one or more processing cores; and
one or more instruction memories storing instructions that, when executed by the one or more processing cores, cause the one or more processing cores to:
maintain a virtual world involving at least a first virtual replica corresponding to a first robot in the real world;
generate one or more virtual events impacting the first virtual replica in the virtual world;
generate a control signal (CTRL) for controlling the first robot in response to the one or more virtual events; and
transmit the control signal (CTRL) to the first robot to modify the behaviour of the first robot and provide a real world response to the one or more virtual events;
an activity zone comprising the first robot and one or more further robots under control of the processing device; and
a tracking system configured to track relative positions and orientations of the first robot and the one or more further robots.

10. The mixed reality system of claim 8, wherein the first robot is a drone or land-based robot.

11. The mixed reality system of claim 8, further comprising one or more user control interfaces for generating user commands (CMD).

12. A method of controlling one or more robots in a mixed reality system, the method comprising:
maintaining, by one or more processing cores under control of instructions stored by one or more instruction memories, a virtual world involving at least a first virtual replica corresponding to a first robot in the real world;
generating one or more virtual events impacting the first virtual replica in the virtual world;
generating a control signal (CTRL) for controlling the first robot in response to the one or more virtual events; and
transmitting the control signal (CTRL) to the first robot to modify the behaviour of the first robot and provide a real world response to the one or more virtual events.

13. The method of claim 12, further comprising:
receiving, by the one or more processing cores prior to generating the control signal (CTRL), a user command intended to control the first robot,
wherein generating the control signal (CTRL) comprises modifying the user command based on the one or more virtual events.

14. The method of claim 13, wherein the virtual world further involves a second virtual replica corresponding to a second robot in the real world, the method further comprising:
generating one or more further virtual events impacting the second virtual replica in the virtual world;
receiving a computer-generated command intended to control the second robot;
generating a further control signal (CTRL) by modifying the computer-generated command based on the one or more further virtual events impacting the second virtual replica; and
transmitting the further control signal (CTRL) to the second robot to modify the behaviour of the second robot and provide a real world response to the one or more further virtual events.
